(19) United States
(12) Patent Application Publication
(10) Pub. No.: US 2016/0088077 A1
(43) Pub. Date: Mar. 24, 2016

(54) SEAMLESS BINARY OBJECT AND METADATA SYNC

(71) Applicant: Microsoft Corporation, Redmond, WA (US)

(72) Inventors: MING LIU, Bellevue, WA (US); BENTHAM CHANG, Bellevue, WA (US); KIRAN AKELLA VENKATA, Bellevue, WA (US)

(21) Appl. No.: 14/490,063

(22) Filed: Sep. 18, 2014

(51) Int. Cl. H04L 29/08; H04L 12/58

(52) U.S. Cl. CPC H04L 67/1095; H04L 67/02; H04L 51/04; H04L 67/1097

(57) ABSTRACT

Techniques for seamless binary object and metadata updating and synchronization are described. A synchronization engine layer at a client can detect an update to a binary object from an application layer; generate a unique identifier for the binary object; request a storage server to create a new version of the binary object with the unique identifier; and after the creation of the new version of the binary object with the unique identifier, request the storage server to update a referencing-metadata-store to refer to the binary object associated with unique identifier.

### BACKGROUND

To effectively scale and support an increasing and geographically dispersed user base, computing systems have grown divisible and distributed. A distributed environment involves a network of computing systems enabling data to be generated and processed at various geographical locations.

The advent of these distributed computing systems has meant that even closely-related resources may be stored on different storage systems. Coordination and synchronization techniques are used between the diverse systems to support the distributed environment. In addition, asynchronous data transfer methods may be used to compensate for speed latencies and connectivity variances between system components.

### BRIEF SUMMARY

Techniques are disclosed that enable improved binary object and metadata updating and synchronization in scenarios where binary objects and the metadata referencing them may be stored separately or synchronized at different rates.

Techniques disclosed herein may include the use of a synchronization layer, or engine, to coordinate the updating of metadata storage and binary objects. An ordered sequence of operations between the synchronization layer of a client and a cloud service or storage server may ensure each client views a version of a particular document (or other metadata store) and the binary object(s) referenced therein with transactional consistency. The control flow enables a client application to experience the illusion of a single simultaneous change (e.g., “atomic”) to both binary object and metadata store during a variety of offline, remote storage, and multiple user scenarios, even in the face of stateless or asynchronous communications protocols.

A method for, from an application-client perspective, seamless and atomic binary object synchronization can include, at the synchronization layer on a client device, receiving a notice of a save action from an application on the client device. When the save action is for a binary data update for an existing referencing-metadata-store, the synchronization layer can inform a server to create a new binary data object version with a first identifier and then inform the server to update the existing referencing-metadata-store to reference the new binary data object version with the first identifier. In this manner, when a binary object is updated, instead of overwriting a previous version of the binary object, a new binary object is created at the server. For a new referencing-metadata-store, the synchronization layer can inform the server to create a new referencing-metadata-store so that there is a referencing-metadata-store to update after creating a new binary object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which some implementations may be carried out.

FIG. 2 shows an example process flow for coordinating the timing and effect of updating operations on binary objects and their referencing-metadata-store.

FIG. 3 illustrates a control flow and interaction between components implementing or utilizing the techniques herein.

FIGS. 4A-4D show block diagrams of an example referencing-metadata-store based on XML files transitioning through various phases of modification.

FIG. 5 shows a block diagram illustrating components of a computing system used in some implementations.

FIG. 6 shows an example system architecture in which an implementation of techniques for seamless binary object and metadata synchronization may be carried out.

### DETAILED DESCRIPTION

Techniques are disclosed that enable improved binary object and metadata updating and synchronization in scenarios where binary objects and the metadata referencing them may be stored separately or synchronized at different rates.

Binary objects, sometimes called “binary large objects” or “blobs,” are discrete units containing an ordered series of binary data that forms a digital representation of a particular type of information. A binary object is often an image, audio, or multimedia entity. A binary object may also be an encoding of information that is specific to a particular application, such as a word processing document, which contains both data and representational commands or elements. Common examples of binary objects are “jpg” image files, “bmp” image files, “way” sound files, and “mp4” multimedia files. Even a word processor document might be considered a “binary object” if attached to an email or linked by another document.

While the term “data” usually refers to information that is directly usable to an application or person, “metadata” refers to data about data. Metadata may store additional context information about the data, such as the last time the data was updated. For example, the words in a simple text file are its data, but the “modified time” on the file is part of its metadata.

Metadata may also be used to direct a process to the location of data. For example, the information about the storage location of a binary object can be stored as location metadata in a document, file or other store that is separate from the storage location of the binary object. For example, a binary object may be stored at a location external to or remote from one or more documents, files or other stores containing the location metadata for the binary object (e.g., the binary object can be an “external binary object”).

A metadata store is any medium that retains information about the location or other properties of data. A metadata store may be embodied in a file, database, document, or even a simple list of key-value pairs as some examples. In a simple case, a metadata store can be a single extensible markup language (XML) file containing tags. The metadata store represented by the XML file can refer to an external binary object such as an image file stored in the file system. A processing engine can read the XML file to extract the location of the binary object (e.g., the image file) from the location metadata, locate the image file, and—in some cases—display the image file. Even an email containing a link to a document may be a metadata store according to this representation.

As used herein, a referencing-metadata-store is a metadata store that references or refers to an external binary object and, as such, may benefit from the coordinated updating and synchronization techniques described herein.

When binary objects and the metadata store referencing them are stored separately, updates to the binary object and the metadata may take place at different speeds. For example, saving a change to a large document file (e.g., binary object) embedded in an email (e.g., a referencing-metadata-store) may take a relatively long amount of time in contrast to the time taken to save a short email that references the large document file. This time disparity may be further exaggerated when files are saved to remote locations, such as cloud storage services, that have greater network latencies.

Sometimes synchronization of binary objects and metadata stores occur between devices that have differing online and offline modes. For example, a desktop computer at an office is generally tethered to a network and is always online, but a laptop computer may not have network connectivity at all times. The asynchronous and non-transactional nature of the updates can be particularly problematic when synchronizing changes to the metadata store and the binary object to remote servers for use by other clients consuming the same binary objects and metadata.

As a result of speed and online/offline device status disparities, the binary object and the metadata store that references the binary object (i.e., the referencing-metadata-store) may enter an inconsistent intermediate system state. In one such inconsistent state, the metadata store update happens quickly while the more time-consuming binary object update takes much longer; the result is that the metadata store references an incomplete, inaccessible, or unavailable version of the binary object. In another, similar inconsistent state, the metadata store updates quickly and is synchronized to a centralized storage site. The metadata store change is quickly replicated to other consumers of the metadata store and binary object, but the underlying binary object takes longer and has not been synchronized. Consequentially, other consumers of the metadata store and binary object then may try to view and work with a newer metadata store which in fact references an older binary object; unanticipated results may ensue.

Techniques disclosed herein may include the use of a synchronization layer, or engine, to coordinate the updating of metadata storage and binary objects. An ordered sequence of operations between the synchronization layer of a client and a cloud service or storage server may ensure each client views a version of a particular document (or other metadata store) and the binary object(s) referenced therein with transactional consistency. The control flow enables a client application to experience the illusion of a single simultaneous change to both binary object and metadata store during a variety of offline, remote storage, and multiple user scenarios, even in the face of stateless or asynchronous communications protocols.

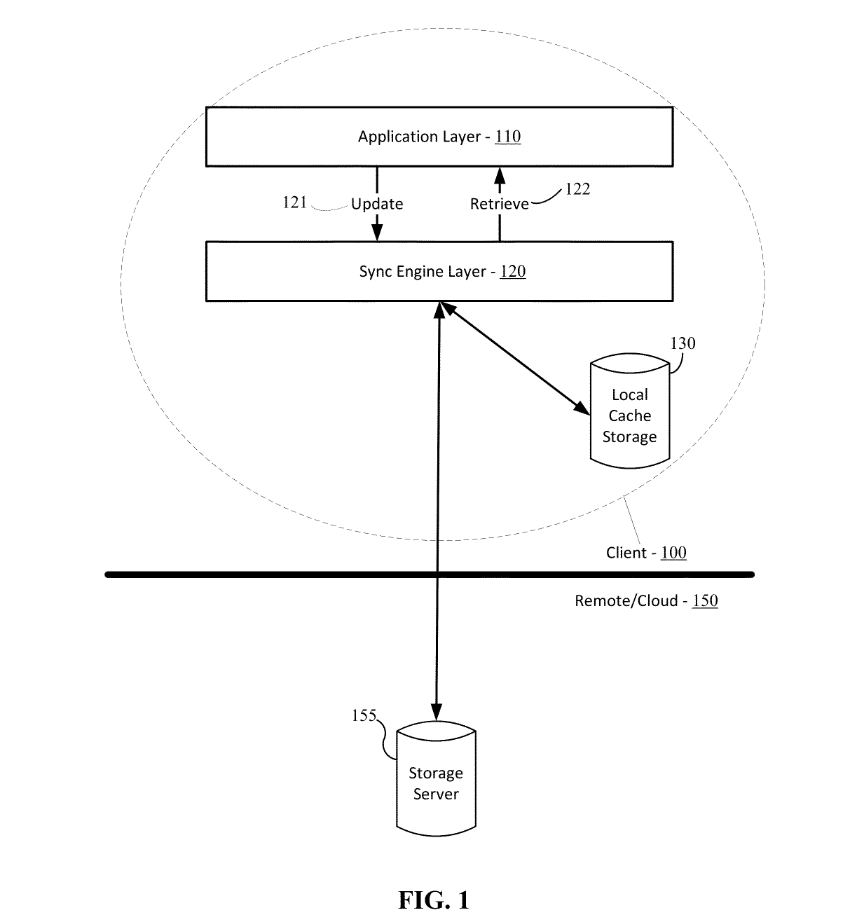

FIG. 1 shows an example component environment in which some implementations may be carried out. In FIG. 1, two processing layers are represented as operative on a client device 100: application layer 110 and sync engine layer 120. Application layer 110 can implement processing instructions to provide the functionality in an end user application such as a word processor, email client, or textual presentation/reader. Sync engine layer 120 can be used to implement some of the binary object metadata sync techniques described herein. Sync engine layer 120 may serve as an intermediate access layer that isolates the application layer 110 from synchronization details. For example, the application layer 110 may experience a seamless and atomic change to a binary object and metadata store during a variety of offline, remote storage, and multiple user scenarios.

As shown in FIG. 1, sync engine layer 120 may intercede to receive requests by the application layer 110 to save a binary object and its metadata. The save request may involve an update (121) to a binary object. Sync engine layer 120 also may provide coordinated services to retrieve (122) a binary object and its metadata, for the application layer 110, from a storage location (for example on the cloud 150).

Since sync engine layer 120 acts as an interceding layer between application layer 110 and underlying storage services, the sync engine layer 120 may coordinate the timing and effect of operations occurring in a local storage cache 130 and/or a storage server 155 present in a remote (e.g., cloud) 150 locality. In some implementations, sync engine layer 120 may modify the sequence or operative effect of operations as they would ordinarily be conducted using standardized operating libraries.

For example, a hypertext transfer protocol (HTTP) “Put” or “Post” command—which updates or creates a resource (e.g., a binary object) on a remote server—may be considered an asynchronous process, meaning that the remote server (e.g., at cloud 150) accepts the request immediately but completes the request in the background. The requestor (e.g., the sync engine layer 120) may subscribe to notifications that inform the requestor when the server has completed the update of the resource. If the request to update a binary object and the request to update the metadata store referring to the binary object are part of a series of uncoordinated save operations, the update to the metadata store may occur far more quickly than the update to the much larger binary object, and an inconsistent state occurs. The operative effect of the sync engine layer 120 is to coordinate the timing and effect of these operations on behalf of the application layer 110 so that transactional consistency is ensured.

The features and functions of sync engine layer 120 and the storage server 155 may be callable through an application programming interface (API). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The API is generally a set of programming instructions and standards for enabling two or more applications to communicate with each other and is commonly implemented over the Internet as a set of HTTP request messages (e.g., the “Put” or “Post” command) and a specified format or structure for response messages according to a REST (Representational state transfer) or SOAP (Simple Object Access Protocol) architecture. The API and related components may be stored in one or more machine-readable storage media (e.g., storage media such as hard drives, magnetic disks, solid state drives, random access memory, flash, CDs, DVDs and the like).

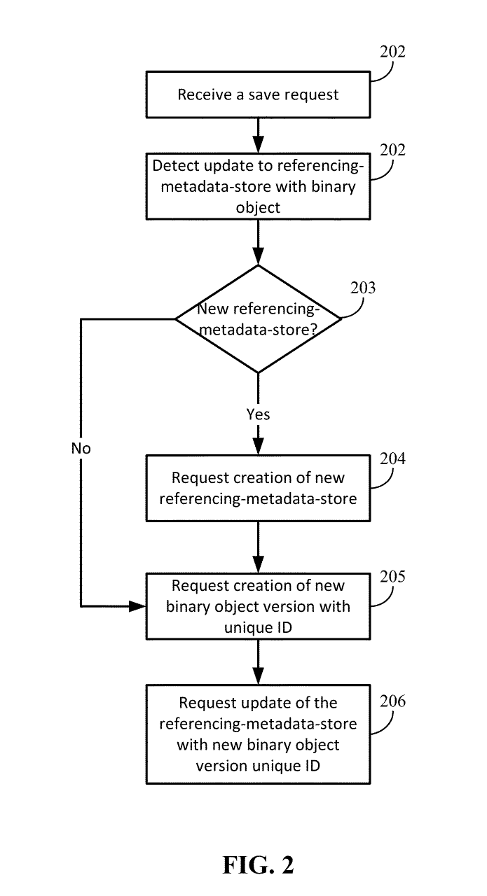

FIG. 2 shows an example process flow for coordinating the timing and effect of updating operations on binary objects and their referencing-metadata-store. This example process flow may be implemented in a sync engine layer, as described above with respect to FIG. 1.

Referring to FIG. 2, a request or notice from the application layer to save a referencing-metadata-store containing a reference to a modified binary object may be received by the sync engine layer (201). For example, the sync engine layer may receive a notice of a save action from an application on a client device. In some cases, this request (or notice) may be initiated by the application using specifically provided API functions exposed by the sync engine. In other cases, the sync engine layer may work transparently by intercepting more basic save and updating functions directed toward a specific area of the file system or storage layers, as for example when the binary objects or referencing metadata store reside in a designated operating system directory that is managed or continuously polled by the sync engine.

Whichever mechanism is used, the sync engine layer can determine from the save request whether there is an update operation involving a referencing-metadata-store and binary object (202). In some cases, there may not be a change to the binary object(s) and/or the referencing-metadata-store referring to the binary object(s). In such a case, the sync engine layer can determine that no updating to cloud is needed. In other cases, there may be a change—either as a modification of an existing binary object and/or referencing-metadata-store or as the creation of a new binary object and/or referencing-metadata-store.

Accordingly, when there is an update operation involving a referencing-metadata-store and binary object (202), the sync engine layer can determine whether the referencing-metadata-store is being newly created to contain the binary object or whether the referencing-metadata-store is extant but needs updating (203). For example, a newly created referencing-metadata-store may be established when an application saves a new document containing a link to an image for the first time. When the sync engine layer identifies such a case, a new referencing-metadata-store can be created (204). In one implementation, the sync engine layer can inform a storage server to create a new referencing-metadata-store via an API. Initially, this new referencing-metadata-store (managed by the server) may be hidden, temporary, inaccessible, or marked with a special non-synchronizable status flag so that a synchronization process does not execute until later processing steps have completed.

Next, for the binary object involved in the update operation, the sync engine layer can request the creation of a new binary object version with an identifier (ID) that is unique (205). The ID can be considered a “unique ID” since the identifier is configured to be statistically unique (e.g., the likelihood that a repeating value occurs is negligible).

In the case where, from operation 203, it is determined that the referencing-metadata-store is not a new referencing-metadata-store (e.g., because the referencing-metadata-store being updated exists), processing can proceed directly to requesting the creation of a new binary object version with unique identifier (205). The request may be via an API of the storage server.

It should be noted that, depending on system design, the determination (203) and creation of a new referencing-metadata-store (204) does not necessarily need to be completed in the order given in the process flow (e.g., before the creation of a new binary object version of operation 205), and may even be optional.

As used here, the term “binary object version” refers to each saved link in a chain of modifications to a particular binary object. Advantageously, in the described techniques, instead of saving a changed binary object over an old binary object, a new binary object version is created having a unique ID. In particular, a new “copy” of the binary object version is created, leaving the existing older version of the binary object intact and unmodified. The new binary object version receives its own unique ID. In some cases, certain activities can be carried out at the server level to clean up the extra existing older versions according to specified processes; however, until the extra older versions are removed, they may still be available at the server (even if not referenced by a particular referencing-metadata-store).

After the new binary object version has been created, the unique ID of the new binary object version may then be used to update the referencing-metadata-store, for example, via a request to a server to update the referencing-metadata-store so that it references the binary object version (206). If the referencing-metadata-store was temporary, hidden, or had a status flag set because it was newly created, the server may activate the referencing-metadata-store after the binary object version is updated. In some cases, the sync engine may request that the server activate the “hidden” referencing-metadata-store after the binary object version is created.

The referencing-metadata-store now may be synchronized using various mechanisms already in place without danger that the referencing-metadata-store will refer to a binary object that has not yet been synchronized to the storage location.

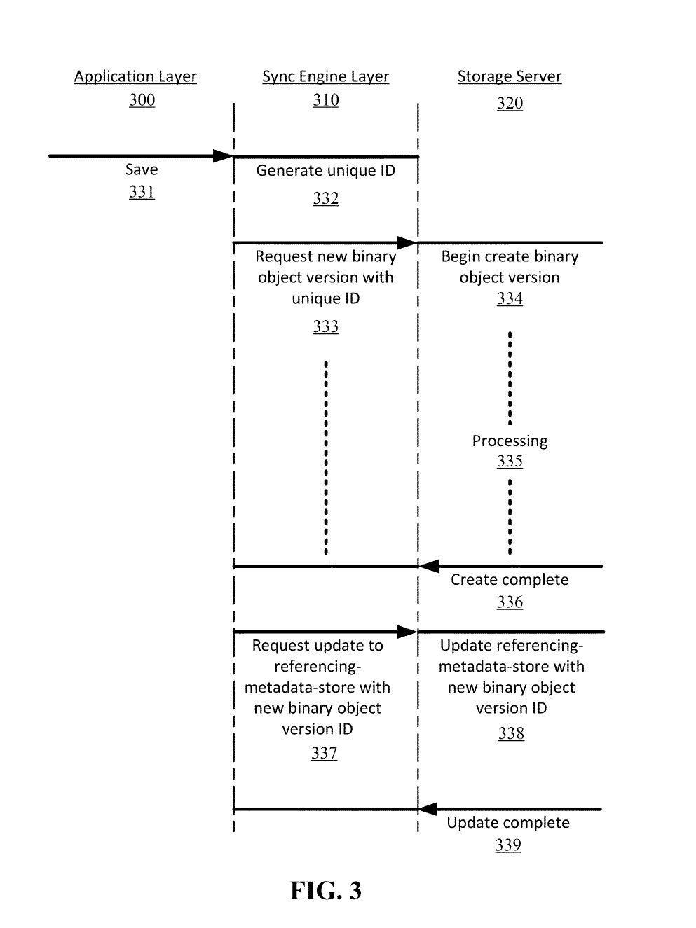

FIG. 3 illustrates a control flow and interaction between components implementing or utilizing the techniques described herein. In FIG. 3, three aspects of a system environment which may be present in some scenarios, application layer 300, sync engine layer 310, and storage server 320, are represented by columnar zones. Operations and functions occurring within that system zone are depicted. Operations which initiate operations within another environmental component (in some cases, via API call) are represented by arrows pointing to that environmental component.

Application layer 300 and sync engine layer 310 may be at a client. Storage server 320 may represent cloud service(s) or server(s) managing the storage of information that can be accessed by (and synchronized for) multiple clients (and other servers). Beginning with the application layer 300, an application or other component may issue an instruction (331) to save a change to a binary object referenced by a referencing-metadata-store (or to save a new binary object and/or referencing-metadata-store). The instruction to save (331) may be explicitly directed at or intercepted by sync engine layer 310. The sync engine layer can then be responsible for updating the referencing-metadata-store and/or binary object to save certain changes to the referencing-metadata-store metadata through communication with the storage server 320, for example through the process described with respect to FIG. 2.

For example, sync engine layer 310 may, in response to determining that there is an update to a binary object (or a new binary object being saved), generate a new identifier for the binary object (332). The new identifier (unique ID) can be used to request that the server 320 store the binary object at a new location as a binary object version with the unique ID (333), which initiates the creation (334) of the new binary object version on the storage server 320. In some cases, the unique ID may be generated (332) by producing a new file name having a random number or timestamp appended to it. The new binary object version, identified by the new name in the request (333), may then be serialized (i.e., written as a data stream) to a newly created file having the new name on the storage server 320.

In the example above, the new unique ID (e.g., file name) may be used to initiate a lower-level API function that can be called asynchronously (i.e., not requiring the calling function to wait for it to complete the operation it executes, which may be time-consuming) to save the binary object data stream to the file. A function of this kind may be provided by the operating system or by a higher-level API, such as that used to implement an HTTP “Post” or “Put” command or a “RESTful” web API function. When asynchronous mechanisms are used, processing 335 continues in parallel on storage server 320 until the binary object data has completed its serialization.

Sync engine layer 310 may wait in a non-blocking “asynchronous wait” to be informed of completion of the serialization for the new binary object version by the storage server 320. When the call has completed, a “create complete” notification may be returned by the storage server 320 to the sync engine layer 310 (336). Upon receipt of the notification that the new binary object version is created, the sync-engine layer 310 may request that the server 320 save or update the referencing-metadata-store with new metadata referencing the new version of the binary object (337), which initiates the updating of the referencing-metadata-store (338). An “update complete” notification may be returned by the storage server 320 to the sync engine layer 310 when the update is complete (339). In some cases, the sync engine server 310 may, before, after, or during the time the server 320 is creating a new binary object version (during processing 335), request creation of a new referencing-metadata-store (not shown). The request of a creation of the new referencing-metadata-store may be performed where there is no existing referencing-metadata-store.

When viewed from the perspective of individual component or environment layers, FIG. 3 illustrates certain technical effects of the disclosed techniques which may improve the processing efficiency or performance of various system layers. Application layer 300 may issue a simple command (“save” 331) to sync engine layer 310 and just the updates are sent to the storage server 320. Since a new identifier is provided for each update of a binary object, the referencing-metadata-store can remain referencing a complete binary object until after the new binary object version is stored.

An email application can be used as an illustrative example. For example, a user may create a new email message having a binary attachment, such as a word processing file. A user may modify content in an email and/or its word processing document attachment and a draft of the email may be saved. Here, the referencing-metadata-store is the email message, and the binary object is the word processing document. The email message may contain little content, so saving the email message to a cloud-based email service may be rapid; however, the separate word processor file may take much longer to update because it must be uploaded from the user's local storage to the cloud-based storage. The disclosed techniques enable the synchronization of the word processing file's upload with the update to the email message metadata store. This allows the user to continue working without waiting for the synchronization of the word processing document.

As another illustrative example, a reader application may include functionality for annotation with image capture so that a user may “write” using a stylus, finger or other input mechanism free-form notes. The annotation metadata such as the location, pen type, page number, time, and ink point array may be available in a referencing-metadata-store, and the binary object is the ink capture image (e.g., a screen capture image). These objects may be stored separately in cloud storage. By using the disclosed techniques to perform synchronization, when a user retrieves an article or other content through a reader application, the annotation metadata and the ink capture image can be seamlessly provided to that end user.

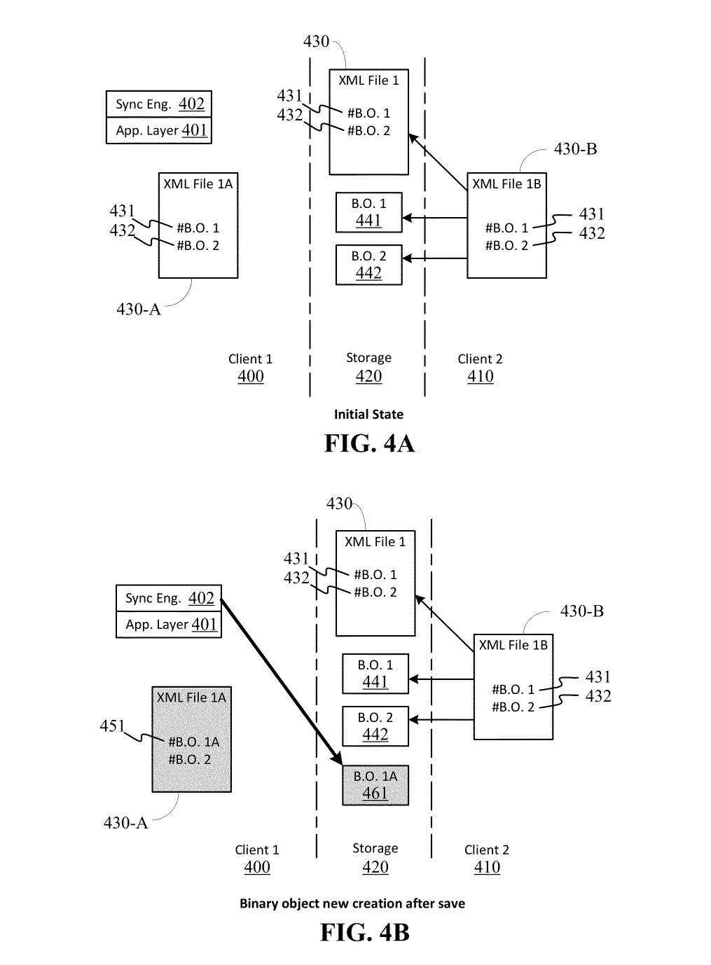

FIGS. 4A-4D show block diagrams of an example referencing-metadata-store based on XML files transitioning through various phases of modification. The figures show certain states of transition as an update to an XML file referencing a binary object is synchronized and propagated through the system components. It should be noted that an XML file is used here as to represent a category of document or file-based referencing-metadata-stores and that use of an XML file type in this example is not intended to be construed as limiting the techniques to that file type. Indeed, many types of application files (e.g., word processor files, reader files, HTML files) have XML-like structural aspects and the capability to reference external binary objects.

Data management techniques can range from highly-ordered organizations of information—where each data element has a place in a rigidly defined structure—to loose collections of unstructured data. Highly-ordered information collections may be managed by relational database management systems (RDBMS) that enforce transactional integrity on changes to data. As a result, a metadata store implemented in an RDBMS may experience few synchronization difficulties.

For scaling data, however, flexible collections of unstructured data can be advantageous because they lack a centralized indexing hierarchy such as may become a processing bottleneck in an RDBMS. These more unstructured methods of data management are sometimes referred to as non-relational, or “NoSQL” databases. One of the simplest forms of a non-relational database uses “documents” or files in the file system to serve as the metadata store. The “database” merely consists of a collection of such metadata store files, many of which may refer to binary objects. A document or file loosely corresponds to a record in an RDBMS table, but contains data which is far less structured in many cases.

In the very simplest document-oriented non-relational databases, the referencing-metadata-store documents/files are merely placed in directories. The file system itself manages the index based on the unique name given to each document, and no other overarching database management system is present.

In one environment of this kind, a collection XML files serve as the referencing-metadata-stores. Any or all of the individual XML files might refer to one or more binary objects located in the same or other storage localities or systems. These binary objects might themselves be files containing a representation of data in a standardized format, for example, an image file with a page scan or photograph, or a multimedia file with video and/or sound recordings. An application that uses a large number of discrete content files is sometimes organized in this manner; examples include an online article database, corporate knowledge management system, or even the pages in a book formatted for a mobile or desktop “reader” application.

Updating binary objects that are under management by a document-oriented non-relational data management system using traditional methods can lead to data inconsistency, as many file-based systems lack the necessary features to ensure consistent update operations across multiple files. With traditional methods, for example, a modification to an embedded binary data object may result in an inconsistent system state between the time the containing file was saved and the time the embedded binary data object was pushed to the cloud storage server. Other clients working with the same document and binary data object might experience inconsistent results due to the latency as the blob is updated. In contrast, such inconsistent results when updating a binary object and/or referencing-metadata-store may be avoided through certain implementations of the techniques described herein.

Turning, for example, to FIG. 4A, an operating environment may involve two clients, a first client 400 and a second client 410, which may access the same information on the cloud or other storage server(s) 420.

First client 400 may be embodied in any suitable computing system. At the first client 400, application layer 401 may be any application for which storage of data in the manner described is suitable, for example a reader application, word processor, email client, or other application. For example, application layer 401 can execute the high-level functions for displaying and modifying the information contained in the XML files stored by the system. Sync engine 402 serves to implement the techniques and functions for seamless binary object and metadata sync such as described above with respect to FIG. 2. Although not shown, an application layer and sync engine may also be implemented at second client 410.

Second client 410 may also be embodied in any suitable computing system. Second client 410 may represent a separate machine, device, or instance that shares access to the same referencing-metadata-store and binary objects as first client 400. As one example, a user may have both a laptop and a desktop computer and desire that the data on both computers be synchronized and updatable. Another system example may be a cloud storage account (here represented by 420) accessed by a user on multiple client devices and form factors, such as a laptop computer and a smartphone.

A centralized storage server (or servers) 420 may store a referencing-metadata-store of a first version of an XML file 430 that includes, for example, a first reference 431 to a first binary object 441 and a second reference 432 to a second binary object 442. The first binary object 441 and the second binary object 442 may also be stored at the storage server 420. Storage server 420 may serve as a shared repository accessible to multiple devices. The storage server 420 may be locally shared, may be remote (e.g., as a storage area on a cloud storage service provider), or may be a combination thereof. It should be noted that the block diagram depicted in FIG. 4A is greatly simplified for clarity and that any number of referencing-metadata-stores (e.g., XML files) may be stored and/or accessed by any number of clients; and any number of binary objects may be stored at the storage server and/or referenced by the referencing-metadata-stores.

In the initial state depicted in FIG. 4A, a local copy 430-A of the XML file 430 can reside at the first client 400, for example at a local storage (not shown). The second client 410 may also access this same XML file 430, and a second local copy 430-B may be viewed and/or stored at the second client 410.

Depending on the frequency of synchronization and the connectivity of the various devices, the version of the referencing-metadata-store and the referenced binary objects may not be the same on all devices. As described in more detail with respect to FIGS. 4B and 4C, when a binary object is updated, the versions of the XML File on each device may go through transitional states in which they are not exact duplicates.

For example, referring to FIG. 4B, application layer 401 may initiate a save operation for the XML File 430-A in which the first binary object is updated. The sync engine 402 can determine that the first binary object (originally located as the first reference 431) has been modified, generate a new reference 451, and request that the storage server 420 create and save a new binary object 461 (e.g., via a put or push request). Sync engine 402 can thus initiate the transfer of a new version of binary object 1, here called “binary object 1A” 461 onto the storage server 420. “XML File 1” 430 remains unmodified with respect to the reference to the new version of the binary object at this time. Accordingly, second client 410 continues to see the XML file 430-B and the first and second binary objects 441, 442 referenced by the first and second references 431, 432.

Upon completion of the creation of the new version of the binary object 461, Sync engine 402 can initiate the update to the “XML File 1” 430 at the storage server 420 as illustrated in FIG. 4C. For example, sync engine 402 can request the storage server 420 to update the “XML File 1” 430 to refer to the new reference 451 of the new version of the first binary object, “binary object 1A” 461.

Note, at this time, “XML File 1B” 430-B on second client 410 remains unmodified and continues to refer to the original version of first binary object 441. This state may persist indefinitely until the newer version of the referencing-metadata-store has been synchronized. Synchronization may not happen until much later, if ever, on second client 410, but the version of the referencing-metadata-store 430-B on second client 410 remains functional until that time.

FIG. 4D shows an optional final system state in which the version of XML File 1 430-B residing on second client 410 has been synced from the storage server 420. Transfer line 470 illustrates this synchronization process between files 430 and 430-B. After synchronization, XML File 1B 430-B now refers to “binary object 1A” 461 via new reference 451. As illustrated by the sequence in FIGS. 4A-4D, XML File 1 remains consistent regardless of the reliability or periodic nature of the mechanism used to synchronize files or other data.

In another use scenario, a centralized metadata and binary object store provided by the sync engine or other system layer (e.g., the operating system) may manage certain synchronization, timing, or coordination functions. These functions may be provided as part of a common function library or application programming interface in order to allow seamless interaction with applications. Applications may use the centralized object and metadata store and be masked from the complexity of implementing a file-oriented approach as described above.

In some implementations, centralized metadata and binary object store may implement a garbage-collection or cleanup routine to periodically iterate through the referencing-metadata-store and remove any versions of binary objects that no longer have a referent. This function may be implemented by a service or background thread configured to execute periodically or at times when system use is lower.

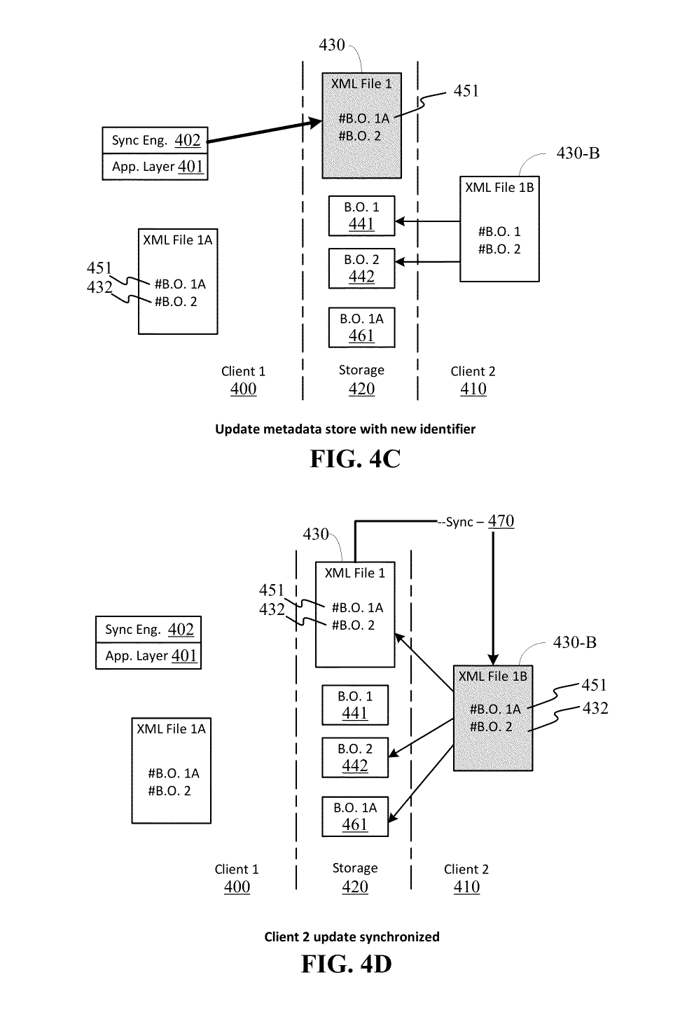

FIG. 5 shows a block diagram illustrating components of a computing system used in some implementations. For example, any client device 100, 400, 410 or storage server 155, 420 or intermediate servers facilitating interaction between client device and storage server may be implemented as system 500, which can include one or more computing devices. As a client device, the system 500 may include a personal computer, a tablet computer, a reader, a mobile device, a personal digital assistant, a wearable computer, a smartphone, a tablet, a laptop computer (notebook or netbook), a gaming device or console, a desktop computer, a smart television, or a server device/computer. As a server, the system 500 may include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The system 500 can include a processing system 501, which may include a processing system such as a central processing unit (CPU) or a microprocessor and other circuitry that retrieves and executes software 502 from storage system 503. Processing system 501 may be implemented within a single processing system but may also be distributed across multiple processing systems or sub-systems that cooperate in executing program instructions.

Examples of processing system 501 include general purpose central processing units, application specific processors, and logic devices, as well as any other type of processing system, combinations, or variations thereof. The one or more processing systems may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 503 may include any computer readable storage media readable by processing system 501 and capable of storing software 502. Storage system 503 may include volatile and nonvolatile, removable and non-removable media implemented in any method or technology for storage of information, such as computer readable instructions, data structures, program modules, or other data.

Examples of storage media include random access memory, read only memory, magnetic disks, optical disks, CDs, DVDs, flash memory, magnetic cassettes, magnetic tape, magnetic disk storage or other magnetic storage devices, or any other suitable storage media. Certain implementations may involve either or both virtual memory and non-virtual memory. In no case do storage media consist of a propagated signal. In addition to storage media, in some implementations storage system 503 may also include communication media over which software 502 may be communicated internally or externally.

Storage system 503 may be implemented as a single storage device but may also be implemented across multiple storage devices or sub-systems co-located or distributed relative to each other. Storage system 503 may include additional elements, such as a controller, capable of communicating with processing system 501.

Software 502 may be implemented in program instructions and among other functions may, when executed by system 500 in general or processing system 501 in particular, direct system 500 or processing system 501 to operate as described herein for enabling seamless binary object and metadata synchronization. Software 502 may provide program instructions that implement an application layer, sync engine, or execute methods or operations that enable access to a storage server. Software 502 may implement on system 500 components, programs, agents, or layers that implement in machine-readable processing instructions the methods described herein as performed by the sync engine, application layer, or other components.

Software 502 may also include additional processes, programs, or components, such as operating system software or other application software. Software 502 may also include firmware or some other form of machine-readable processing instructions executable by processing system 501.

In general, software 502 may, when loaded into processing system 501 and executed, transform system 500 overall from a general-purpose computing system into a special-purpose computing system customized to facilitate seamless binary object and metadata synchronization. Indeed, encoding software 502 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage.

System 500 may represent any computing system on which software 502 may be staged and from where software 502 may be distributed, transported, downloaded, or otherwise provided to yet another computing system for deployment and execution, or yet additional distribution.

It should be noted that many elements of system 500 may be included in a system-on-a-chip (SoC) device. These elements may include, but are not limited to, the processing system 501, a communications interface 504, and even elements of the storage system 503 and software 502.

In embodiments where the system 500 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 504 may be included, providing communication connections and devices that allow for communication between system 500 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

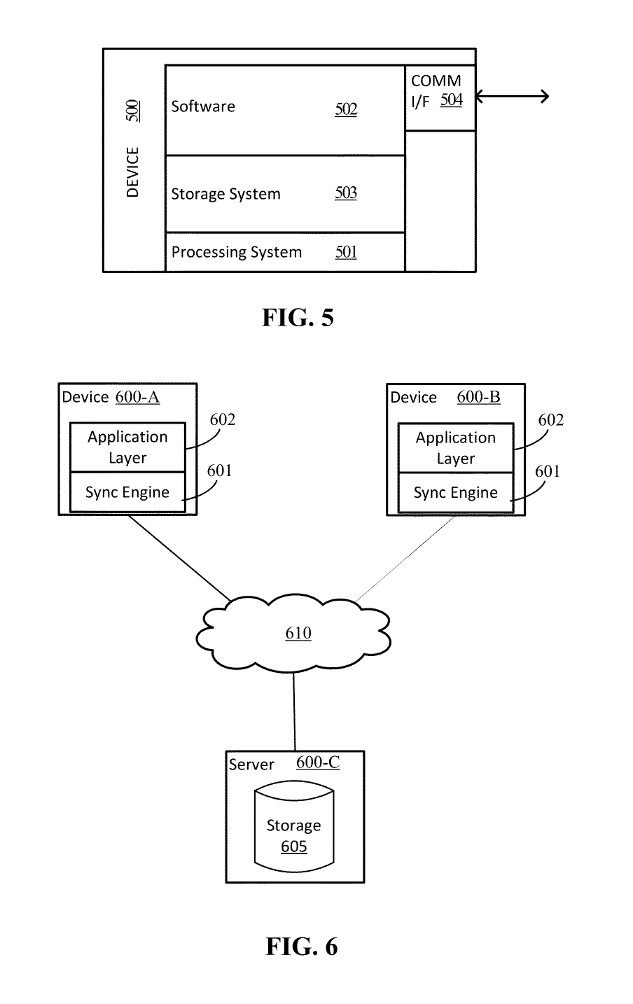

FIG. 6 illustrates an example system architecture in which an implementation of techniques for seamless binary object and metadata synchronization may be carried out. In the example illustrated in FIG. 6, a sync engine 601 and application layer 602 can be implemented on a system 600-A or 600-B, which may be particular instantiations of a system 500 as described with respect to FIG. 5. The sync engine 601 may be implemented as software or hardware (or a combination thereof) on the system 600-A or 600-B. The sync layer 601 directs application layer binary object updates to the appropriate storage server 600-C having storage system 605 over network 610. It should be noted that while two systems shown (600-A and 600-B) are shown, this depiction is not intended to limit the environment to a particular number of systems implementing sync engines.

The network 610 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

FIG. 6 shows system components operative on separate systems 600-A, 600-B, and 600-C. It should be noted, however, that any or all of the software components described above as sync engine 601, application layer 602, or storage 605 need not be run on separate systems, and may indeed be run on the same system.

Certain aspects of the invention provide the following non-limiting embodiments:

### Example 1

A method for seamless and atomic binary object synchronization at a client, comprising: detecting an update to a binary object from an application layer; generating a unique identifier for the binary object; requesting creation of a new version of the binary object with the unique identifier; and after the creation of the new version of the binary object with the unique identifier, requesting an update of a referencing-metadata-store to refer to the binary object associated with unique identifier.

### Example 2

The method of example 1, further comprising: detecting a second update to the binary object from the application layer; generating a second unique identifier for the binary object; requesting creation of a second new version of the binary object with the second unique identifier; and after the creation of the second new version of the binary object with the second unique identifier, requesting a second update of the referencing-metadata-store to refer to the second new version of the binary object associated with the second unique identifier instead of the new version of the binary object associated with the unique identifier.

### Example 3

The method of examples 1 or 2, wherein requesting creation of the new version of the binary object with the unique identifier comprises a hypertext transfer protocol (HTTP) request.

### Example 4

The method of any of examples 1-3, further comprising: receiving a request from the application layer to save a referencing-metadata-store containing a reference to the binary object; determining whether or not the referencing-metadata-store exists; and if the referencing-metadata-store is determined to not exist: requesting creation of a new referencing-metadata-store, wherein the requesting of the update of the referencing-metadata-store is a request to update the new referencing-metadata-store.

### Example 5

The method of any of examples 1-4, wherein the referencing-metadata-store comprises a file such as a word processor file, reader file, HTML file, or XML file.

### Example 6

The method of any of examples 1-4, wherein the referencing-metadata-store comprises a reader file containing annotation metadata and the binary object comprises an image.

### Example 7

The method of any of examples 1-4, wherein the referencing-metadata-store comprises a document.

### Example 8

The method of any of examples 1-5, wherein the referencing-metadata-store comprises an email message.

### Example 9

An apparatus comprising: one or more computer readable storage media; program instructions for a synchronization layer stored on at least one of the one or more computer readable media that, when executed by a processing system, direct the processing system to: detect an update to a binary object from an application layer; generate a unique identifier for the binary object; request creation of a new version of the binary object with the unique identifier; and after the creation of the new version of the binary object with the unique identifier, request an update of a referencing-metadata-store to refer to the binary object associated with the unique identifier.

### Example 10

The apparatus of example 9, wherein the program instructions for the synchronization layer, when executed by the processing system, further direct the processing system to: detect a second update to the binary object from the application layer; generate a second unique identifier for the binary object; request creation of a second new version of the binary object with the second unique identifier; and after the creation of the second new version of the binary object with the second unique identifier, request a second update of the referencing-metadata-store to refer to the second new version of the binary object associated with the second unique identifier instead of the new version of the binary object associated with the unique identifier.

### Example 11

The apparatus of examples 9 or 10, wherein the request of the creation of the new version of the binary object with the unique identifier comprises a hypertext transfer protocol (HTTP) request.

### Example 12

The apparatus of any of examples 9-11, wherein the program instructions for the synchronization layer, when executed by the processing system, further direct the processing system to: in response to receiving a request from the application layer to save a referencing-metadata-store containing a reference to the binary object, determine whether or not the referencing-metadata-store exists; and if the referencing-metadata-store is determined to not exist, request creation of a new referencing-metadata-store, wherein the request of the update of the referencing-metadata-store is a request to update the new referencing-metadata-store.

### Example 13

The apparatus of any of examples 9-12, wherein the referencing-metadata-store comprises a file such as a word processor file, reader file, HTML file, or XML file.

### Example 14

The apparatus of any of examples 9-12, wherein the referencing-metadata-store comprises a reader file containing annotation metadata and the binary object comprises an image.

### Example 15

The apparatus of any of examples 9-13, wherein the referencing-metadata-store comprises an email message.

### Example 16

A system comprising: one or more computer readable storage media; program instructions stored on at least one of the one or more computer readable media that, when executed by a processing system, direct the processing system to: in response to receiving a request to create a new version of a binary object with a unique identifier, save the new version of the binary object associated with the unique identifier and provide a notification that the new version of the binary object has been created; and in response to receiving a request to update a referencing-metadata-store to refer to the binary object associated with the unique identifier, update the referencing-metadata-store to refer to the binary object associated with the unique identifier.

### Example 17

The system of example 16, wherein the program instructions, when executed by the processing system, further direct the processing system to: in response to receiving a request to create a second new version of the binary object with a second unique identifier, save the second new version of the binary object associated with the second unique identifier and provide a second notification that the second new version of the binary object has been created; and in response to receiving a request to update the referencing-metadata-store to refer to the second new version of the binary object associated with the second unique identifier, update the referencing-metadata-store to refer to the second new version of the binary object associated with the second unique identifier instead of the new version of the binary object associated with the unique identifier.

### Example 18

The system of examples 16 or 17, wherein the program instructions, when executed by the processing system, further direct the processing system to: in response to receiving a request to create a new referencing-metadata-store, create the new referencing-metadata-store.

### Example 19

The system of example 18, wherein the request of the update of the referencing-metadata-store is a request to update the new referencing-metadata-store, wherein the new referencing-metadata-store is hidden until receipt of the request to update the referencing-metadata-store to refer to the binary object associated with the unique identifier.

### Example 20

The system of example 19, wherein the program instructions, when executed by the processing system, further direct the processing system to: un-hide the hidden new referencing-metadata-store after receiving the request to update the referencing-metadata-store to refer to the binary object associated with the unique identifier.

### Example 21

The system of any of examples 18-20, wherein the new referencing-metadata-store is marked with a non-synchronizable status flag upon creation of the new referencing-metadata-store; and the non-synchronizable status flag is unmarked after receiving the request to update the referencing-metadata-store to refer to the binary object associated with the unique identifier.

### Example 22

The sync engine of any of examples 16-21, further comprising instructions stored on at least one of the one or more computer readable media that, when executed by the processing system, direct the processing system to: periodically iterate through the referencing-metadata-store to determine binary objects being referred to therein; and remove any versions of binary objects that no longer have a referent in the referencing-metadata-store.

### Example 23

The sync engine of any of examples 16-21, wherein the referencing-metadata-store comprises a file such as a word processor file, reader file, HTML file, or XML file.

### Example 24

The sync engine of any of examples 16-21, wherein the referencing-metadata-store comprises a reader file containing annotation metadata and the binary object comprises an image.

### Example 25

The sync engine of any of examples 16-21, wherein the referencing-metadata-store comprises a document.

### Example 26

The sync engine of any of examples 16-21, wherein the referencing-metadata-store comprises an email message.

### Example 27

A system for seamless and atomic binary object synchronization at a client, comprising: a means for detecting an update to a binary object from an application layer; a means for generating a unique identifier for the binary object; a means for requesting creation of a new version of the binary object with the unique identifier; and a means for requesting an update of a referencing-metadata-store to refer to the binary object associated with unique identifier after the creation of the new version of the binary object with the unique identifier.

### Example 28

The system of example 27, further comprising: detecting a second update to the binary object from the application layer; generating a second unique identifier for the binary object; requesting creation of a second new version of the binary object with the second unique identifier; and after the creation of the second new version of the binary object with the second unique identifier, requesting a second update of the referencing-metadata-store to refer to the second new version of the binary object associated with the second unique identifier instead of the new version of the binary object associated with the unique identifier.

### Example 29

The system of examples 27 or 28, wherein the means for requesting creation of the new version of the binary object with the unique identifier comprises a means for performing a hypertext transfer protocol (HTTP) request.

### Example 30

The system of any of examples 27-29, further comprising: a means for receiving a request from the application layer to save a referencing-metadata-store containing a reference to the binary object; a means for determining whether or not the referencing-metadata-store exists; and a means for requesting creation of a new referencing-metadata-store if the referencing-metadata-store is determined to not exist, wherein the means for requesting of the update of the referencing-metadata-store performs a request to update the new referencing-metadata-store.

### Example 31

The system of any of examples 27-30, wherein the referencing-metadata-store comprises a file such as a word processor file, reader file, HTML file, or XML file.

### Example 32

The system of any of examples 27-30, wherein the referencing-metadata-store comprises a reader file containing annotation metadata and the binary object comprises an image.

### Example 33

The system of any of examples 27-30, wherein the referencing-metadata-store comprises a document.

### Example 34

The system of any of examples 27-31, wherein the referencing-metadata-store comprises an email message.

It should be understood that the examples and embodiments described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for seamless and atomic binary object synchronization at a client, comprising:
detecting an update to a binary object from an application layer;
generating a unique identifier for the binary object;
requesting creation of a new version of the binary object with the unique identifier; and
after the creation of the new version of the binary object with the unique identifier, requesting an update of a referencing-metadata-store to refer to the binary object associated with unique identifier.

2. The method of claim 1, further comprising:
detecting a second update to the binary object from the application layer;
generating a second unique identifier for the binary object;
requesting creation of a second new version of the binary object with the second unique identifier; and
after the creation of the second new version of the binary object with the second unique identifier, requesting a second update of the referencing-metadata-store to refer to the second new version of the binary object associated with the second unique identifier instead of the new version of the binary object associated with the unique identifier.

3. The method of claim 1, wherein requesting creation of the new version of the binary object with the unique identifier comprises a hypertext transfer protocol (HTTP) request.

4. The method of claim 1, further comprising:
receiving a request from the application layer to save a referencing-metadata-store containing a reference to the binary object;
determining whether or not the referencing-metadata-store exists; and
if the referencing-metadata-store is determined to not exist:
requesting creation of a new referencing-metadata-store, wherein the requesting of the update of the referencing-metadata-store is a request to update the new referencing-metadata-store.

5. The method of claim 1, wherein the referencing-metadata-store comprises a file.

6. The method of claim 1, wherein the referencing-metadata-store comprises a document.

7. The method of claim 1, wherein the referencing-metadata-store comprises an email message.

8. An apparatus comprising:
one or more computer readable storage media;
program instructions for a synchronization layer stored on at least one of the one or more computer readable media that, when executed by a processing system, direct the processing system to:
detect an update to a binary object from an application layer;
generate a unique identifier for the binary object;
request creation of a new version of the binary object with the unique identifier; and
after the creation of the new version of the binary object with the unique identifier, request an update of a referencing-metadata-store to refer to the binary object associated with the unique identifier.

9. The apparatus of claim 8, wherein the program instructions for the synchronization layer, when executed by the processing system, further direct the processing system to:
detect a second update to the binary object from the application layer;
generate a second unique identifier for the binary object;
request creation of a second new version of the binary object with the second unique identifier; and
after the creation of the second new version of the binary object with the second unique identifier, request a second update of the referencing-metadata-store to refer to the second new version of the binary object associated with the second unique identifier instead of the new version of the binary object associated with the unique identifier.

10. The apparatus of claim 8, wherein the request of the creation of the new version of the binary object with the unique identifier comprises a hypertext transfer protocol (HTTP) request.

11. The apparatus of claim 8, wherein the program instructions for the synchronization layer, when executed by the processing system, further direct the processing system to:
in response to receiving a request from the application layer to save a referencing-metadata-store containing a reference to the binary object, determine whether or not the referencing-metadata-store exists; and
if the referencing-metadata-store is determined to not exist, request creation of a new referencing-metadata-store, wherein the request of the update of the referencing-metadata-store is a request to update the new referencing-metadata-store.

12. The apparatus of claim 8, wherein the referencing-metadata-store comprises a file.

13. The apparatus of claim 8, wherein the referencing-metadata-store comprises an email message.

14. A system comprising:
one or more computer readable storage media;
program instructions stored on at least one of the one or more computer readable media that, when executed by a processing system, direct the processing system to:
in response to receiving a request to create a new version of a binary object with a unique identifier, save the new version of the binary object associated with the unique identifier and provide a notification that the new version of the binary object has been created; and
in response to receiving a request to update a referencing-metadata-store to refer to the binary object associated with the unique identifier, update the referencing-metadata-store to refer to the binary object associated with the unique identifier.

15. The system of claim 14, wherein the program instructions, when executed by the processing system, further direct the processing system to:
in response to receiving a request to create a second new version of the binary object with a second unique identifier, save the second new version of the binary object associated with the second unique identifier and provide a second notification that the second new version of the binary object has been created; and
in response to receiving a request to update the referencing-metadata-store to refer to the second new version of the binary object associated with the second unique identifier, update the referencing-metadata-store to refer to the second new version of the binary object associated with the second unique identifier instead of the new version of the binary object associated with the unique identifier.

16. The system of claim 14, wherein the program instructions, when executed by the processing system, further direct the processing system to:
in response to receiving a request to create a new referencing-metadata-store, create the new referencing-metadata-store.

17. The system of claim 16, wherein the request of the update of the referencing-metadata-store is a request to update the new referencing-metadata-store, wherein the new referencing-metadata-store is hidden until receipt of the request to update the referencing-metadata-store to refer to the binary object associated with the unique identifier.

18. The system of claim 17, wherein the program instructions, when executed by the processing system, further direct the processing system to:
un-hide the hidden new referencing-metadata-store after receiving the request to update the referencing-metadata-store to refer to the binary object associated with the unique identifier.

19. The system of claim 16, wherein the new referencing-metadata-store is marked with a non-synchronizable status flag upon creation of the new referencing-metadata-store; and the non-synchronizable status flag is unmarked after receiving the request to update the referencing-metadata-store to refer to the binary object associated with the unique identifier.

20. The sync engine of claim 14, further comprising instructions stored on at least one of the one or more computer readable media that, when executed by the processing system, direct the processing system to:
periodically iterate through the referencing-metadata-store to determine binary objects being referred to therein; and
remove any versions of binary objects that no longer have a referent in the referencing-metadata-store.
